(19) United States
(12) Patent Application Publication
(10) Pub. No.: US 2014/0058864 A1
(43) Pub. Date: Feb. 27, 2014

(54) COMMODITY REGISTRATION APPARATUS AND METHOD

(71) Applicant: TOSHIBA TEC KABUSHIKI KAISHA, Tokyo (JP)

(72) Inventor: Hideaki Sugiyama, Shizuoka-ken (JP)

(73) Assignee: TOSHIBA TEC KABUSHIKI KAISHA, Tokyo (JP)

(21) Appl. No.: 13/960,979

(22) Filed: Aug. 7, 2013

(30) Foreign Application Priority Data
Aug. 23, 2012 (JP) 2012-184267

(51) Int. Cl. G06Q 20/20

(52) U.S. Cl. CPC G06Q 20/202
USPC 705/21

(57) ABSTRACT

A commodity registration apparatus includes a tablet apparatus which an input section and a display section of a screen respectively arranged on a housing and an information processing section configured to carry out a commodity sales registration processing and a checkout processing by the input section and the display section and determine the registration of the commodities purchased in a transaction by the closing operation input from the input section, a wireless transmission section configured to wirelessly transmit an issuing instruction of receipt information containing the content of the transaction by the tablet apparatus to a printing device and a notification section configured to display a transaction completion notice on the display section by the closing operation input to the information processing section of the tablet apparatus which makes the wireless transmission section transmit the issuing instruction.

### CROSS-REFERENCE TO RELATED APPLICATION

This application is based upon and claims the benefit of priority from Japanese Patent Application No. 2012-184267, filed Aug. 23, 2012, the entire contents of which are incorporated herein by reference.

### FIELD

Embodiments described herein relate to a commodity registration apparatus and a commodity registration method.

### BACKGROUND

A POS (Point of Sales) terminal having a sales registration function and a checkout function is arranged in a store. Conventionally, a POS system is known which is used as a mobile terminal capable of carrying a handy POS terminal. A commodity sales data processing apparatus is known which carries out customer service using a portable device.

### BRIEF DESCRIPTION OF THE DRAWINGS

FIG. 1 is a diagram illustrating the configuration of a POS system comprising the commodity registration apparatus according to one embodiment;

FIG. 2 is a six-figures of the commodity registration apparatus according to the embodiment;

FIG. 3 is a flowchart illustrating the display of a transaction completion notice of the commodity registration apparatus according to the embodiment; and

FIG. 4 is a diagram illustrating an example of a transaction completion notice displayed by a commodity registration apparatus according to the embodiment.

### DETAILED DESCRIPTION

In accordance with an embodiment, a commodity registration apparatus includes a tablet apparatus which has a housing, an input section and a display section of a screen respectively arranged on the housing and an information processing section configured to carry out a commodity sales registration processing and a checkout processing through the input section and the display section and determine the registration of the commodities purchased in a transaction on the screen by the closing operation input through the input section, a wireless transmission section configured to wirelessly transmit an issuing instruction of receipt information containing the content of the transaction by the tablet apparatus to the wireless interface section of a printing device and a notification section configured to display a transaction completion notice on the display section by the closing operation input to the information processing section of the tablet apparatus which makes the wireless transmission section transmit the issuing instruction.

In addition, in accordance with another embodiment, a commodity registration method for a tablet apparatus which has a housing, an input section and a display section of a screen respectively arranged on the housing, including: carrying out a commodity sales registration processing and a checkout processing through the input section and the display section and determining the registration of the commodities purchased in a transaction on the screen by the closing operation input through the input section; wirelessly transmitting an issuing instruction of receipt information containing the content of the transaction by the tablet apparatus to a wireless interface section of a printing device; and displaying a transaction completion notice on the display section by a closing operation input to an information processing section of the tablet apparatus.

The commodity registration apparatus and method according to the embodiments are described below with reference to accompanying drawings 1-4, in each of which the same reference signs denote the same portions respectively and is therefore not described repeatedly.

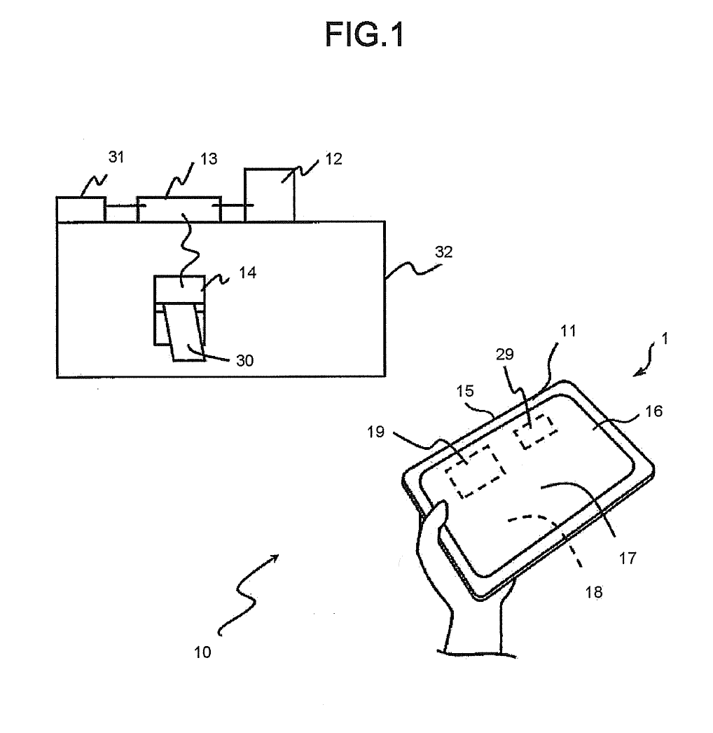

FIG. 1 is a diagram illustrating the configuration of a POS system comprising the commodity registration apparatus according to the embodiments. The POS system 10, a system arranged in the point-of-sale location in a store, comprises: a POS terminal 1 (commodity registration apparatus) carried by a shop clerk moving in the store; a wireless interface device (wireless interface section) on a payment counter 32 wirelessly communicating with the POS terminal 1 within a short distance; a USB (universal serial bus) device server 13 (device server) connected with the wireless interface device 12 which is arranged on the payment counter 32 through a cable; a wireless portable printer 14 (printing device) suspended from the payment counter 32 and connected with the USB device server 13 through a cable; and a drawer 31 located on the payment counter 32.

The POS terminal 1, is a movable commodity registration apparatus which carries out a commodity sales registration and a checkout processing and enabling the portable printer 14 to issue a receipt, and comprises a tablet PC (Personal Computer) (tablet apparatus). The tablet PC 11 has a plate-shaped housing 15, a display section 17 arranged on the housing 15 to display a screen 16, an input section 18 arranged on the display section 17 to detect a touch on the screen 16 and an information processing section 19 configured to carry out commodity sales registration and a checkout processing based on the touch input.

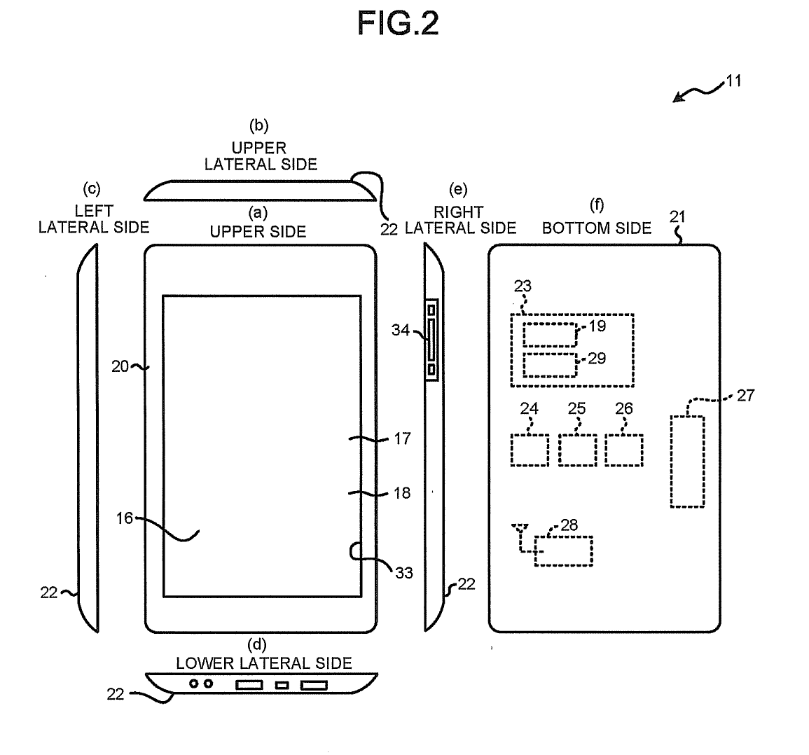

FIG. 2 is a six-figures of the POS terminal 1, in which the reference signs described above denote the same components. The ‘upper’, ‘lower’, ‘left’, ‘right’ shown in FIG. 2(b)-FIG. 2(e) indicate positions corresponding to the upper, lower, left, right parts of FIG. 2(a). The housing 15 (FIG. 1) comprise an upper plate 20 having a transparent opening 33 thereon, a bottom plate 21 for supporting a palm or finger and a plurality of lateral plates 22.

The display section 17 is a liquid crystal or organic EL (Electro Luminescence) display for displaying a checker screen during a commodity sales registration and a cash screen during a settlement, the display section 17 displaying a screen 16 from the opening 33. The input section 18 detects the pressing of a screen key representing a commodity category or a value on the checker screen and the pressing of a key representing a deposit amount on a settlement screen. The input section 18 is a transparent pointing device for input, which sends the touch coordinate information touched by a fingertip or pen-type input device on a panel to the information processing section 19. Moreover, the POS terminal 1 comprises a wireless module 28 (wireless transmission section) for a short-distance wireless communication, which wirelessly transmits receipt information containing the content of a transaction of the information processing section 19 and an issuing instruction of the receipt information to the wireless interface device 12 and receives wireless data from the wireless interface device 12.

Moreover, the POS terminal 1 further comprises a notification section 29 which displays a transaction completion notice on the display section 17 according to the closing operation input to the input section 18 of the tablet PC 11 which makes the wireless module 28 transmits the receipt issuing instruction. The notification section 29 carries out the notice being triggered by the output of the issuing instruction from the information processing section 19 to the wireless module 28. The notification section 29 carries out the notice being triggered by the reception of the response to the issuing instructions from the wireless interface device 12 by the wireless module 28. The notification section 29 may also carry out the notice being triggered by the pressing of the screen key on the screen 16 of the display section 17.

The POS terminal 1 comprises a CPU (central processing unit) 23, a ROM (read only memory) 24, a RAM (random access memory) 25 and a nonvolatile storage section 26. The CPU 23, the ROM 24 and the RAM 25 constitute the information processing section 19 and the notification section 29 together. The CPU 23 executes the program stored in the ROM 24 to enable the tablet PC 11 (computer) to function as the POS terminal 1. The CPU 23 enables the tablet PC 11 to execute the functions of: carrying out a commodity sales registration and a checkout processing according to the touch input and the displaying content on the screen 16 and determining the registration of the commodities purchased in a transaction on the screen 16 according to the closing operation input; transmitting an issuing instruction of the receipt information containing the content of a transaction to the wireless interface device 12 through the wireless module 28; and displaying a transaction completion notice on the display section 17 according to the closing operation input to the information processing section 19. The storage section 26 has a storage area for storing a pre-downloaded commodity master file and a storage area for storing a transaction file serving as sales information. The storage section 26 has a storage area for storing an application program to display the content of a sales registration screen and a settlement screen on the display section 17. The storage section 26 is a flash memory. Besides, the POS terminal 1 may further comprise an interface section 27 which is configured to transmit and receive files with another PC device through an opened general port 34 on one lateral plate 22.

The wireless interface device 12 shown in FIG. 1 carries out wireless communication with the POS terminal 1 in accordance with, for example, the IEEE (institute of electrical and electronic engineers) 802.15.1 standard. For example, the wireless interface device 12 carries out communication with the POS terminal 1 in accordance with a procedure specified by Bluetooth (registered trademark) profile to transmit and receive receipt information and a control command with the POS terminal 1 within a distance of several or a dozen of meters (m). The wireless interface device 12 carries out a wired bidirectional communication with the USB device server 13.

The USB device server 13 is a device control device which connects devices equipped with a USB interface with each other. The USB device server 13 is connected with the wireless interface device 12 and the portable printer 14 through USB connectors. The USB device server 13 accommodates the portable printer 14 so that the POS terminal 1 can access the portable printer 14 via the USB device server 13. The POS terminal 1 may carry out receipt printing in a state the same as the state in which the POS terminal 1 is directly connected with the portable printer 14.

The portable printer 14 is, for example, a thermal printer. The portable printer 14 comprises a USB interface, a buffer memory, a processor and a printing device. The printing device draws out rolled thermal paper, conveys the extracted paper to an issuing port, and prints receipt information through a thermal head which is in the direction of facing across the paper in a paper conveyance path on the paper. The portable printer 14 horizontally outputs the printed receipt 30. The drawer 31 is connected through the USB device connector 13. Change amount information and deposit amount information are notified from the POS terminal 1.

The POS terminal 1 having the structure above connects the general port 34 with another upper device in advance to download a commodity master file to the storage section 26. The POS terminal 1 establishes a wireless link with the wireless interface device 12 before or after the downloading. The operator of the POS terminal 1, that is, the shop clerk, carries the POS terminal 1 and carries out customer service, for example, while walking in the store with a VIP customer to make commodities instructions.

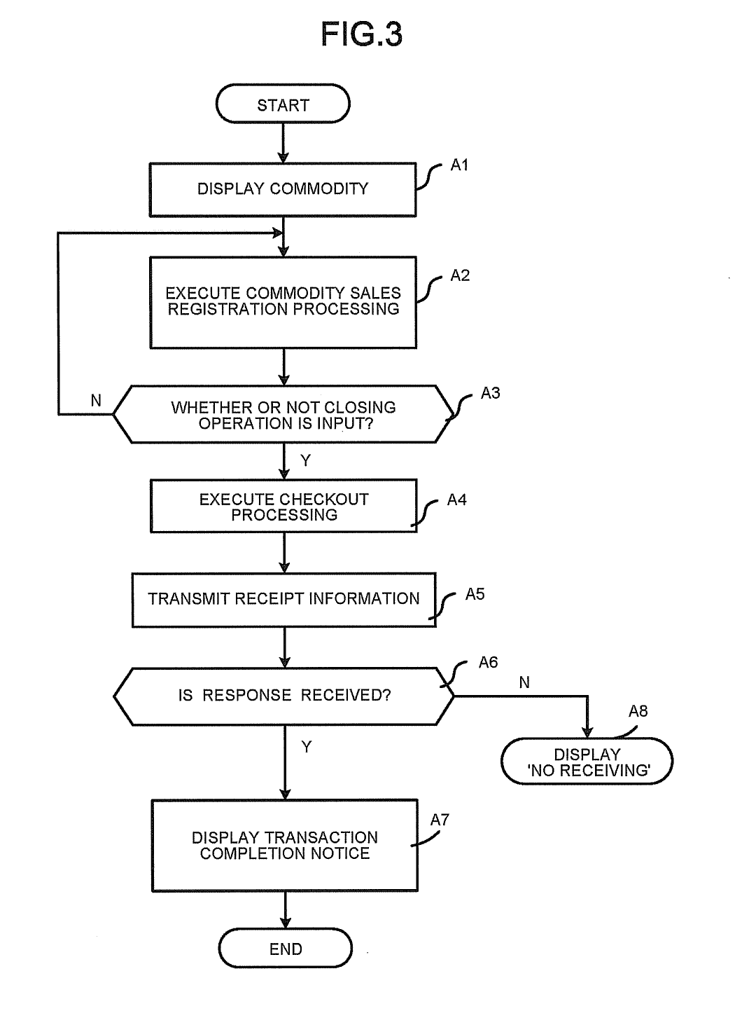

FIG. 3 is a flowchart illustrating the display of a transaction completion notice by the POS terminal 1. In Act A1, the POS terminal 1 for example, selects and displays commodity information from the menus displayed on the screen. In Act A2, the POS terminal 1 executes a commodity sales registration processing. The POS terminal 1 displays a checker screen on the screen 16 and displays a plurality of pre-input icons or keys representing images and prices of commodity samples. When an optional icon or key is selected through the operation of the shop clerk, the POS terminal 1 accesses the commodity master file to retrieve commodity information corresponding to a commodity. In Act A2, the POS terminal 1 displays the commodity name, unit price, sales number and subtotal amount corresponding to the last registered commodity code. When more than one kind of commodities is traded in one transaction, the POS terminal 1 displays the subtotal amount or the total amount of the commodities registered aiming at all commodity information.

In Act A3, the POS terminal 1 determines whether or not the software key, that is, the closing key, on the screen is pressed and carries out the processing in Act A2 through a route N during the period in which the closing key is pressed hasn't been detected. If the POS terminal 1 detects that the closing operation is input in Act A3, then the POS terminal 1 executes a checkout processing through a route Y in Act A4. In Act A4, the POS terminal 1 carries out, for example, a change amount operation. The POS terminal 1 displays sales volume, tax amount, requested amount, deposit amount and change amount or the like on the display section 17.

In Act A5, the POS terminal 1 generates the sales volume, tax amount, requested amount, deposit amount and change amount or the like acquired from the transaction operation as receipt information to be printed. The POS terminal 1 sends information containing the receipt information, a receipt issuing request command and identification information of the portable printer 14 to the wireless interface device 12. The portable printer 14 issues the receipt 30. The wireless interface device 12 sends printing completion notice message to the POS terminal 1. For example, the drawer 31 is opened on such a condition that the drawer 31 receives an operation input of opening confirmation from the shop clerk standing by the payment counter 32.

After receipt information is transmitted in Act A5, in Act A6, the POS terminal 1 monitors whether or not message of the printing completion is received, if the POS terminal 1 receives the message, then a transaction completion notice is displayed on the display section 17 in Act A7 through a route Y.

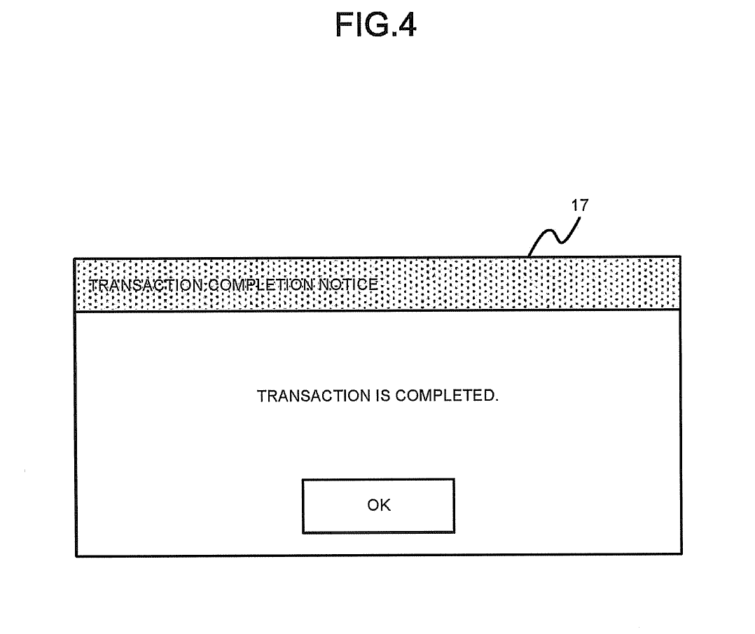

FIG. 4 is a diagram illustrating an example of a transaction completion notice according to the POS terminal 1. The reference signs described above denote the same components, respectively. The shop clerk is aware that the receipt is issued and the transaction is completed normally according to the display shown in the same diagram. The shop clerk prompts the customer to receive change and a receipt at the payment counter 32. In FIG. 4, the POS terminal 1 may insert the display of ‘To counter xxx please’ at the location of the payment counter 32. The customer heads to the payment counter 32 leaving the shop clerk carrying the POS terminal 1 and receives a receipt and change from another shop clerk there. The shop clerks in the floor are aware that all the transactions related to the customer are ended and then starts customer service to another customer.

Even when moving in the floor and using the POS terminal 1 serving as a mobile terminal, the shop clerk can know the completion timing of each transaction.

Further, in Act A4, Act A5 or Act A7, the POS terminal 1 stores the determined commodity information of one transaction appended with a transaction number in transaction data.

Further, if the POS terminal 1 determines, by monitoring the time of a timer, that the message is not received in Act A6, then the POS terminal 1 displays no receiving on the display section 17 in Act A8 through a route N. Then, the shop clerk can know that the customer receives no receipt as receipt paper is run out or blocked.

### Variation Embodiment

In aforementioned examples, the tablet apparatus is a touch input type tablet PC 11 by a touch panel, however, a plurality of commodity menus and numbers can be selectively displayed on the commodity information screen displayed on the display section 17 by using a pull-down menu or a context menu. In a commodity registration screen and a checkout processing screen, a commodity menu, numeric and amount may be selected from the pull-down menu or one of the commodity icons displayed in a window may be selected, in this case, the tablet apparatus may not be of a touch input type. In this case, commodity information strings, the number of the commodity purchased or a settlement amount may not be input directly like by the tablet PC 11, the commodity registration apparatus according to the embodiments can carry out a substantially identical processing. The commodity registration apparatus frequently using a pull-down menu, commodity icons or price selection menus maybe configured an input section (not shown) and a screen display section (not shown) in the housing 15 as a tablet apparatus, and carries out a commodity sales registration processing and a checkout processing according to the input section and the display section, and the information processing section 19 may determine the closing input according to the closing operation input of the input section.

In the embodiment, the POS system 10 comprises one portable printer 14; however, a plurality of portable printers 14 may be configured in a sale-of-point. The USB device server 13 may issue a receipt by an optional portable printer 14 according to the inherent device identification information (inherent information) of the portable printers 14 and fixed printers (not shown).In the POS terminal 1, the notification section 29 displays, on the display section 17, the printer name (inherent information of a corresponding printing device) of the portable printer 14 for printing a receipt. According to the touch operation of the operator, the POS terminal 1 selects an output printer. The POS terminal 1 sends, through the wireless module 28, wireless data containing receipt information and receipt issuing request to an optional one of the portable printers 14. The corresponding portable printer 14 issues a receipt.

Further, the POS terminal 1 may display a transaction completion notice by taking the input of the closing key as a trigger, without conducting the determination processing of Act 6.

Further, the present invention is not limited to the embodiments described herein, and in implementation, the component can be transformed to be embodied without departing from the scope of the present invention. The commodity registration apparatus may further be an ECR (electronic cash register) in this description. The wireless interface device 12 and the USB device server 13 constitute a wireless interface; however, a wireless interface may be set on the printing device.

The POS system 10 may further house and communicate with a plurality of POS terminals 1.

The notification section 29 carries out a display by taking the reception of receipt issuing completion as a trigger, however, the notification section 29 may further be configured to additionally output a signal indicating the completion of the checkout settlement and carries out a display by taking the reception of the one signal as a trigger. The information processing section 19 and the notification section 29 are configured separated from each other; however, the function of the notification section 29 may be installed in the information processing section 19. The commodity registration apparatus related to embodiments subjected to such variations are not degraded in superiority.

The portable printer 14 is arranged on the payment counter or be replaced by a movable portable printer suspended from the body of the shop clerk. The portable printer is a printer fixed and suspended on the belt in the waist of the shop clerk by a hook.

The POS terminal 1 may use another communication standard for the short-distance wireless communication, for example, a specific low-power wireless LAN specified by the IEEE 802.11 x.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity registration apparatus, comprising:
a tablet apparatus which has an input section and a display section of a screen respectively arranged on a housing and an information processing section configured to carry out a commodity sales registration processing and a checkout processing by the input section and the display section and determine a registration of the commodities purchased in a transaction by the closing operation input from the input section;
a wireless transmission section configured to wirelessly transmit an issuing instruction of receipt information containing the content of the transaction by the tablet apparatus to a printing device; and
a notification section configured to display a transaction completion notice on the display section by the closing operation input to the information processing section of the tablet apparatus which makes the wireless transmission section transmit the issuing instruction.

2. The commodity registration apparatus according to claim 1, wherein
the notification section carries out the notice being triggered by the output of the issuing instruction from the information processing section to the wireless transmission section.

3. The commodity registration apparatus according to claim 1, wherein
the wireless transmission section has a function of receiving wireless data from the wireless interface section; and
the notification section carries out the notice being triggered by the reception of the response to the issuing instruction from the wireless interface section by the wireless transmission section.

4. The commodity registration apparatus according to claim 1, wherein
The notification section carries out the notice being triggered by the pressing of a screen key on the screen of the display section.

5. The commodity registration apparatus according to claim 1, wherein
the wireless transmission section sends wireless data to an optional one of a plurality of printing devices identified according to inherent information; and
the notification section displays the inherent information of a corresponding printing device for printing a receipt on the display section.

6. A commodity registration method for a tablet apparatus which has an input section and a display section of a screen respectively arranged on a housing, including:
carrying out a commodity sales registration processing and a checkout processing by the input section and the display section and determining a registration of the commodities purchased in a transaction by the closing operation input from the input section;
wirelessly transmitting an issuing instruction of receipt information containing the content of the transaction by the tablet apparatus to a printing device; and
displaying a transaction completion notice on the display section by a closing operation input to an information processing section of the tablet apparatus.
